(19) United States
(12) Patent Application Publication
(10) Pub. No.: US 2024/0309477 A1
(43) Pub. Date: Sep. 19, 2024

(54) System and method for pyrolysis driven reduced iron production using integrated thermal management

(71) Applicant: Molten Industries Inc., Oakland, CA (US)

(72) Inventors: Kevin A. Bush, Oakland, CA (US); Caleb C. Boyd, Menlo Park, CA (US)

(21) Appl. No.: 18/600,495

(22) Filed: Mar. 8, 2024

Related U.S. Application Data
(60) Provisional application No. 63/451,073, filed on Mar. 9, 2023.

(51) Int. Cl. C21B 13/00; C21B 13/02

(52) U.S. Cl. CPC C21B 13/0073; C21B 13/02; C21B 2100/40

(57) ABSTRACT

A system and method for obtaining a metal oxide reduction product in a metal oxide reduction reaction using a pyrolysis-derived hydrogen from a pyrolysis reactor that pyrolyzes a hydrocarbon feedstock to deliver pyrolysis gases that include the pyrolysis-derived hydrogen, a pyrolysis carbon product and a hydrocarbon fraction of unreacted hydrocarbon feedstock. Pyrolysis gases are fed through a high-temperature carbon separator to separate the pyrolysis carbon product and then flow at a working temperature below pyrolyzation temperature to a reduction furnace that runs the metal oxide reduction reaction such that the pyrolysis-derived hydrogen participates in that reaction. A thermal management system maintains the working temperature of the pyrolysis gases and manages the processing of unreacted pyrolysis-derived hydrogen through heat exchange and other thermal management techniques and tools.

### CROSS-REFERENCE TO RELATED APPLICATIONS

This application claims priority from U.S. Provisional Patent Application No. 63/451,073 filed on Mar. 9, 2023 and which is incorporated herein by reference for all purposes in its entirety.

### FIELD OF THE INVENTION

The present invention relates generally to carbon-neutral iron and steel production, and more specifically to the integration of methane pyrolysis driven clean hydrogen production with a direct iron reduction process with a focus on heat integration and low electrical energy intensity.

### BACKGROUND OF THE INVENTION

About 8% of global CO₂ emissions result from steel production, and over 75% of the CO₂ footprint of steel production comes from the reduction of iron ore (Fe₂O₃) to metallic iron (Fe). FIG. 1A (Prior Art) illustrates schematically the baseline process in use today for roughly 75% of metallic iron production. This baseline process typically uses carbon coke 10 obtained from coal 12 through thermal distillation in a coke oven 14. The process deploys a blast furnace 16 (BF) where carbon coke 10 is partially oxidized to CO to reduce iron ore 18, which is typically delivered in the form of iron pellets. The reduced iron ore or reduced iron (Fe) (also referred to as metallic iron) is shown in the form of hot metal 20. Reduced iron 20 is further processed in a basic oxygen furnace 22 (BOF) to produce crude steel 24, resulting in 1.9 kg CO₂/kg steel emitted in the process. The main gases involved in the baseline process are shown in highly magnified molecular form within dashed and dotted outlines for clarity.

A majority of major steel manufacturers agree that the most feasible path towards decarbonizing steel production is to achieve reduction of iron ore 18, typically delivered in the form of iron pellets, in a direct reduced iron shaft furnace (DRI). This approach is shown in the schematic diagram of FIG. 1B (Prior Art) featuring a direct reduced iron shaft furnace 26 (DRI). Reduction in DRI shaft furnace 26 is followed by processing to steel 24 in an electric arc furnace 28 (EAF) shown in partial cross-section and exploded view to better visualize its interior and the electrodes. Such process has been successfully commercialized by Midrex and Tenova HYL. Note that scrap metal 25 can be added to reduced iron 20 for processing in EAF 28.

Today, the reducing agent for direct reduced iron shaft furnace 26 (DRI) reaction is a mixture of carbon monoxide (CO) and hydrogen (H₂) formed via reforming of natural gas 30. Natural gas 30 is visualized in highly magnified molecular form within dashed and dotted outline by its most abundant component, methane (CH₄). This reaction leads to CO₂ emissions when the carbon monoxide (CO) reacts with iron ore 18 to produce iron in the form of hot metal 20. CO₂ emissions are also produced during combustion of coal or natural gas to provide heat for the reduction reaction. Midrex's natural gas DRI 26 and electric arc furnace 28 (EAF) process for producing steel 24 with virgin ore emits 1.1-1.2 kg CO₂/kg steel. This is a 30-50% reduction in CO₂ intensity over the baseline blast furnace (BF) and basic oxygen furnace (BOF) route illustrated in FIG. 1A. A summary of the reactions is found in Table 1 below.

TABLE 1

| | Enthalpy | |
|---|---|---|
| Reaction | (kJ/mol) | |
| 4.5C + 4.5O₂ --> 4.5CO₂ | −1770.7905 | exothermic combustion |
| 4.5C + 4.5CO₂ --> 9CO | 776.0655 | endothermic Boudouard Reaction |
| 9C + 4.5O₂ --> 9CO | −994.725 | Net partial combustion |
| 3Fe₂O₃ + 9CO --> | −74.256 | Exothermic |
| 6Fe + 9CO₂ | | |
| 3Fe₂O₃ + 9C + 4.5O₂ --> | −1068.981 | Net energy generation—used to |
| 6Fe + 9CO₂ | | heat reaction to ~1200 C. |

To produce carbon neutral or “green” steel, most decarbonization pathways accepted by the industry involve the use of several approaches and technologies. Most of these decarbonization pathways propose using carbon capture and storage to capture CO₂ emissions from BF plus BOF plants or natural gas DRI plants, electrochemically reducing iron ore to iron, or producing H₂ from water electrolysis to replace natural gas and act as the reducing agent to replace CO in a DRI shaft furnace (see FIG. 1B). Carbon capture and storage present hurdles with gaseous carbon dioxide management and storage and also with electrochemical reduction of iron at scale, which is highly energy intensive, has yet to be commercially demonstrated and requires significant new infrastructure.

As seen in FIG. 1B, replacing natural gas 30 with hydrogen in DRI shaft furnace 26 is attractive because it utilizes existing DRI 26 and EAF 28 infrastructure. It also represents a technological step change from existing DRI plants, which already reform natural gas to a mixture of H₂ and CO. The primary barriers to commercialization are the cost of hydrogen and availability of hydrogen at scale from water electrolysis, which is typically performed in an electrolysis vessel 32 using an electricity supply 34. Hydrogen 32 obtained from electrolysis is usually stored underground in a storage vessel 36. Production of DRI with hydrogen is a well-studied and technically feasible process, although to date no commercial scale iron reduction plant with 100% hydrogen as the reductant has been demonstrated. A summary of the reactions is found in Table 2 below.

TABLE 2

| | Enthalpy | |
|---|---|---|
| Reaction | (kJ/mol) | |
| 9H₂O --> 9H₂ + 4.5O₂ | 2572.2 | Energy intensive water |
| | | electrolysis |
| 3Fe₂O₃ + H₂ --> 2Fe₃O₄ + H₂O | −6.018 | |
| 2Fe₃O₄ + 2H₂ --> 6FeO + | 121.164 | |
| 2H₂O | | |
| 6FeO + 6H₂ --> 6Fe + 6H₂O | 181.092 | |
| 3Fe₂O₃ + 9H₂ --> 6Fe + 9H₂O | 296.238 | Net Reduction of Iron Oxide |
| | | with Hydrogen—Endothermic |
| 3Fe₂O₃ --> 6Fe + 4.5O₂ | 2868.44 | Net Reaction energy with |
| | | electrolysis |

Water electrolysis is highly energy intensive and relies on low-cost intermittent wind and solar energy. To produce a steady stream of hydrogen in quantities needed for commercial-scale DRI plants, significant new electric grid infrastructure and expensive hydrogen compression and storage infrastructure are required. Additionally, alternative sources of carbon must be chemically incorporated into steel and they also play an important role in the EAF process. Finally, there is a need to tune the DRI shaft furnace process to run with pure H₂, which is technically feasible but remains to be demonstrated in a shaft furnace at commercial scale.

To overcome the challenges with integration, transport, storage and cost of hydrogen from water electrolysis, Bhaskar et al. have proposed the integration of methane pyrolysis with direct reduction of iron. Methane pyrolysis involves the thermal decomposition of methane or biomethane into solid carbon and hydrogen in an oxygen-free environment to avoid the formation of carbon dioxide. Methane pyrolysis is a well-studied process, with patents dating back to 1915 from Auguste Jean Paris (U.S. Pat. No. 1,756,877), and exists at commercial scale. Methane pyrolysis uses 5-7 times less electricity than water electrolysis, making it significantly less reliant on low electricity prices, enabling the continuous production of hydrogen using grid electricity or renewable electricity from hydro-electric, nuclear or wind and solar with energy storage. This continuous output of hydrogen is critical for the operation of a DRI furnace and makes the integration very attractive.

However, the integration proposed by Bhaskar et al. requires a very high temperature pressure swing adsorption. Furthermore, Bhaskar's integration does not address the problem of solid carbon separation from the methane pyrolysis process, and it does not address the incorporation of carbon into the iron for the eventual creation of steel.

### Objects and Advantages

It is an object of the invention to overcome the limitations of existing iron reduction processes by reducing carbon dioxide emissions by 85% over current blast furnace (BF) steel production.

It is another object to overcome the current challenges with the integration of hydrogen from water electrolysis with direct reduction of iron, such as the need to compress, transport and store hydrogen in order to output a continuous and high temperature feed of hydrogen to an iron reduction furnace.

It is also an object of the invention to decrease energy intensity over the current state of the art in order to decrease the usage of electricity and specifically renewable electricity.

Yet another object of the invention is to overcome other significant shortcomings of existing steel production from the baseline process technology shown in FIG. 1A (Prior Art) and state of the art DRI technology using natural gas (NG DRI) or electrolytic hydrogen (eH₂ DRI) shown in FIG. 1B (Prior Art).

### SUMMARY OF THE INVENTION

The objects and advantages of the invention are provided for by obtaining a metal oxide reduction product such as reduced iron (Fe) in a metal oxide reduction reaction using a pyrolysis-derived hydrogen. The process for obtaining the metal oxide reduction product includes a step of providing a pyrolysis reactor for pyrolyzing a hydrocarbon feedstock, such as methane or natural gas, into pyrolysis gases at a pyrolyzation temperature between 500° C. and 1,600° C. The pyrolysis gases thus obtained essentially comprise a pyrolysis carbon product, a hydrocarbon fraction and the pyrolysis-derived hydrogen.

Another step involves feeding the pyrolysis gases from the pyrolysis reactor to at least one high-temperature carbon separator for separating the pyrolysis carbon product from the pyrolysis gases. The high-temperature carbon separator can be a high-temperature cyclone, a high-temperature baghouse filter or a high-temperature candle filter, including a sintered candle filter able to operate at high temperatures. This step is performed while maintaining the pyrolysis gases at a working temperature that is below the pyrolyzation temperature. For example, the working temperature ranges from above 300° C. to preferably even above 900° C. Furthermore, the pyrolysis carbon product that is separated typically includes mostly solid carbon. Preferably, the at least one high-temperature carbon separator separates out over 60% and up to and over 90% of the pyrolysis carbon product from the pyrolysis gases.

Yet another step involves providing a flow of the pyrolysis gases from the at least one high-temperature carbon separator to a reduction furnace. The reduction furnace is running the metal oxide reduction reaction such that the pyrolysis-derived hydrogen participates in the metal oxide reduction reaction. The metal oxide reduction reaction can be practiced with a metal oxide selected from the group consisting of iron ore, tin oxide, lead oxide, nickel oxide, copper oxide and cobalt oxide.

It is further advantageous to include in the process for obtaining the metal oxide reduction product a thermal management system. The thermal management system is designed for maintaining the working temperature of the pyrolysis gases. In some embodiments, the thermal management system is designed to dry and combust an unreacted hydrogen portion of the pyrolysis-derived hydrogen to obtain high-temperature gases for injection into the reduction furnace in order to add heat. In some other embodiments, the thermal management system is designed to dry and inject into the flow of the pyrolysis gases the unreacted hydrogen portion for cooling the flow of pyrolysis gases prior to entry into the reduction furnace. Further, the thermal management system can have a recycle loop for recirculating a reduction furnace exit gas into the reduction furnace.

In some cases, the pyrolysis carbon product is fluidized out of the pyrolysis reactor by the pyrolysis gases. Further, when the hydrocarbon feed is methane it is advantageous to maintain the efficiency of the pyrolysis reaction such that the pyrolysis-derived hydrogen is obtained with a yield of more than 70%.

The invention also provides for a system to obtain a metal oxide reduction product in a metal oxide reduction reaction with pyrolysis-derived hydrogen. The system has a pyrolysis reactor for pyrolyzing a hydrocarbon feedstock into pyrolysis gases at a pyrolyzation temperature such that the pyrolysis gases essentially include a pyrolysis carbon product, a hydrocarbon fraction and the pyrolysis-derived hydrogen. The system also has at least one high-temperature carbon separator for receiving the pyrolysis gases from the pyrolysis reactor and for separating the pyrolysis carbon product from the pyrolysis gases while maintaining the pyrolysis gases at a working temperature below the pyrolyzation temperature. The system is further equipped with a reduction furnace for receiving a flow of the pyrolysis gases from the at least one high-temperature carbon separator. The reduction furnace runs the metal oxide reduction reaction such that the pyrolysis-derived hydrogen participates in the metal oxide reduction reaction.

The system has a thermal management system for maintaining the working temperature of the pyrolysis gases. Advantageously, the thermal management system has a heat exchanger and is configured for drying and combusting an unreacted hydrogen portion of the pyrolysis-derived hydrogen. Thus, the thermal management system obtains high temperature gases for injection into the reduction furnace in order to add heat.

Alternatively, the thermal management system with a heat exchanger is configured for drying and injecting the unreacted hydrogen portion of the pyrolysis-derived hydrogen into the flow of the pyrolysis gases. This cools the flow of the pyrolysis gases prior to entry into the reduction furnace.

In the same or other embodiments the thermal management system has a recycle loop. The recycle loop is designed for recirculating a reduction furnace exit gas into the reduction furnace.

The present invention, including the preferred embodiment, will now be described in detail in the below detailed description with reference to the attached drawing figures.

### BRIEF DESCRIPTION OF THE DRAWING FIGURES

FIG. 1A (Prior Art) is a schematic diagram of the prior art baseline process

FIG. 1B (Prior Art) is a schematic diagram of a prior art state of the art process using direct a direct reduced iron shaft furnace (DRI)

FIG. 2 is a schematic diagram of a system for obtaining a metal oxide reduction product in a metal oxide reduction reaction using pyrolysis-derived hydrogen according to the invention

FIG. 3 is a flow diagram of the main steps performed in the process of obtaining a metal oxide reduction product according to the invention using the system of FIG. 2

FIG. 4A is a schematic diagram of another system using a thermal management system according to the invention

FIG. 4B is a schematic diagram of the system of FIG. 4A using a different thermal management system according to the invention

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

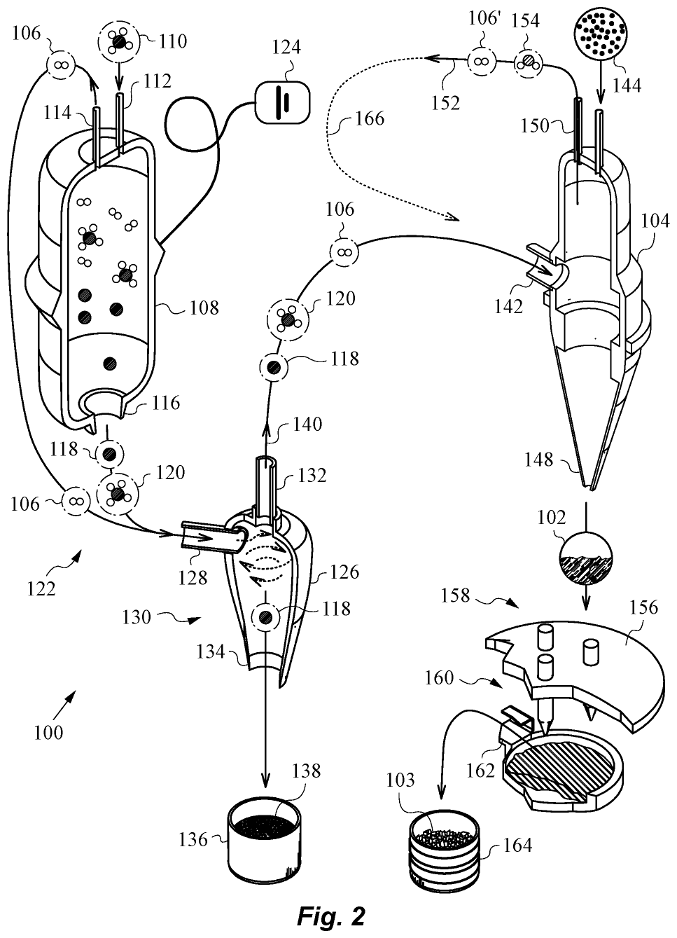

FIG. 2 is a schematic diagram of a system 100 for obtaining a metal oxide reduction product 102. In the present example, metal oxide reduction product 102 is embodied by reduced iron (Fe) or metallic iron shown in molten form. Reduced iron 102 in obtained in a metal oxide reduction reaction performed in a reduction furnace 104 using a pyrolysis-derived hydrogen 106.

In the present example reduced iron 102 is further processed to steel 103, which constitutes the final product in this particular embodiment. Note that system 100 illustrates the most basic components or parts that are required to derive metal oxide reduction product 102, here reduced iron, in accordance with the invention. The view afforded by FIG. 2 illustrates a number of these components in an isometric view and with cutaways for clarity.

System 100 has a pyrolysis reactor 108 for pyrolyzing a hydrocarbon feedstock 110 such as methane or natural gas. In the present embodiment hydrocarbon feedstock is natural gas 110. Natural gas 110 is visualized in highly magnified molecular form by its most abundant component, methane (CH₄), within a dashed and dotted outline.

Pyrolysis reactor 108 has an inlet 112 for admitting natural gas 110. Further, pyrolysis reactor 108 has a top outlet 114 for releasing pyrolysis-derived hydrogen 106. At the bottom, pyrolysis reactor 108 has a bottom outlet 116 for releasing a pyrolysis carbon product 118.

Pyrolysis carbon product 118 in the present embodiment is solid carbon visualized in highly magnified molecular form within a dashed and dotted outline. Pyrolysis reactor 108 also releases a hydrocarbon fraction 120. Hydrocarbon fraction 120 at bottom outlet 116 is principally composed of unreacted natural gas 110. Hence, it is also visualized in highly magnified molecular form within dashed and dotted outline by its most abundant component, methane (CH₄). More generally, however, hydrocarbon fraction 120 will consist of a variety of hydrocarbons such as methane, ethane, ethylene, acetylene, and aromatic hydrocarbons. Together, pyrolysis-derived hydrogen 106, pyrolysis carbon product 118 and hydrocarbon fraction 120 constitute pyrolysis gases 122.

Pyrolysis reactor 108 is connected to an electrical power supply 124 for heating pyrolysis reactor 108 to a pyrolyzation temperature between 500° C. and 1,600° C. Preferably, power supply 124 can generate a sufficient amount of power to reach pyrolyzation temperatures above 1,100° C. and thus drive pyrolyzation, also known as cracking or direct decomposition in an oxygen-free environment where hydrocarbons thermochemically decompose, without catalyst. At such pyrolyzation temperature the yield of methane in natural gas 110 fed into pyrolysis reactor 108 to pyrolyzation-derived hydrogen 106 can be in excess of 50%.

System 100 has a high-temperature carbon separator 126 positioned to receive pyrolysis gases 122. High-temperature carbon separator 126 can be a high-temperature cyclone, a high-temperature baghouse filter or a high-temperature candle filter. The last includes sintered candle filters designed to operate at high temperatures. Independent of the specific type chosen, high-temperature carbon separator 126 is designed to operate at the high temperature at which pyrolysis gases 122 from pyrolysis reactor 108 enter it during operation.

In the present embodiment, high-temperature carbon separator 126 is a high-temperature cyclone 126 with a peripheral inlet 128 for admitting pyrolysis gases 122 into its interior. Since pyrolysis gases 122, namely pyrolysis-derived hydrogen 106, pyrolysis carbon product 118 and hydrocarbon fraction 120 of unreacted natural gas 110, exit pyrolysis reactor 108 at temperatures above 1,000° C. cyclone 126 is a duly insulated, high-temperature cyclone. Preferably, steel or stainless steel piping that has a ceramic refractory lining is used to transport pyrolysis gases 122 from bottom outlet 116 of pyrolysis reactor 108 to a cyclone inlet 128. Cyclone inlet 128 for receiving pyrolysis gases 122 is also preferably insulated and made of materials that can withstand the high temperature of pyrolysis gases 122. An interior chamber 130 of cyclone 126 is likewise insulated and made of materials that can withstand the high temperature of pyrolysis gases 122.

The design of high-temperature carbon separator 126 for solid-gas separation such as high-temperature cyclone of the present embodiment is well understood by skilled artisans. Specifically, pyrolysis gases 122 undergo separation within interior chamber 130 of high-temperature cyclone 126 due to a vortex that produces a helical flow pattern indicated by the dashed arrows. More precisely, pyrolysis gases 122 enter high-temperature cyclone 126 and rotate around a central outlet pipe 132 at lower pressure. A majority of the large and heavy pyrolysis carbon product 118 drops out under gravity through a bottom outlet 134 of interior chamber 130.

Thus, pyrolysis carbon product 118 is separated from pyrolysis gases 122. A collection vessel 136 is positioned below bottom outlet 134 for collecting pyrolysis carbon product 118, which at this point is mostly composed of solid carbon 138. It is important to minimize the amount of pyrolysis-derived hydrogen 106 gas that is allowed to escape through bottom outlet 134. Therefore, collection vessel 136 into which solid carbon 138 is deposited is appropriately sealed with suitable elements (not shown). One option for such sealing is to use a dual cartridge load lock where solid carbon 138 is collected in parallel gas-tight load locks, which are alternately sealed and evacuated. The evacuated gas is used to refill the load lock to minimize loss of pyrolysis-derived hydrogen 106. Preferably, the loss of pyrolysis-derived hydrogen 106 from high-temperature cyclone 126 is kept below 5%.

Central outlet pipe 132 at the top of interior chamber 130 allows the remainder of pyrolysis gases 122 to exit high-temperature cyclone 126 in the form of a flow 140. Pyrolysis gases 122 exiting through central outlet pipe 132 at the top as flow 140 consist mostly of pyrolysis-derived hydrogen 106. However, they also contain a small amount of hydrocarbon fraction 120 composed of unreacted methane (CH₄) and a small amount of pyrolysis carbon product 118 that did not get separated in high-temperature cyclone 126. Although the amount of the last is small, FIG. 2 still indicates the small amount of pyrolysis carbon product 118 present in flow 140 exiting through central outlet pipe 132.

The diameter of high-temperature cyclone inlet 128 and central outlet pipe 132 as well as the pressure drop through high-temperature cyclone 126 are key parameters in determining the separation efficiency. Separation efficiency is a measure of how efficiently solid particles are separated from the gas stream, in this case from the stream of pyrolysis gases 122 arriving from pyrolysis reactor 108. Typically, larger particles are much easier to separate than smaller particles. A series of high-temperature cyclones can be used to ensure separation of the majority of the solid carbon 138. It is noted that cyclone design parameters and optimization are well-known to those skilled in the art.

Specifically, in situations where high-temperature cyclone 126 is not able to separate out a sufficient amount of pyrolysis carbon product 118 from pyrolysis gases 122 by itself, additional cyclones are added in series with cyclone 126 (not shown). A sufficient number of cyclones should be provided to ensure a separation efficiency high enough for a majority of pyrolysis carbon product 118 to be separated out from pyrolysis gases 122. In particular, when pyrolysis carbon product 118 that is separated typically is mostly solid carbon 138, then preferably the at least one cyclone separates out over 60% up to and over 90% of pyrolysis carbon product 118 from pyrolysis gases 122. Preferably, however, not all of the pyrolysis carbon product 118 is separated for reasons that are further explained below.

Flow 140 of pyrolysis gases 122 largely consisting of pyrolysis-derived hydrogen 106 is maintained at a working temperature that is below the pyrolyzation temperature, but is still high. In the present example, the working temperature is above 1,000° C. In general, depending on the embodiment, working temperature ranges from above 300° C. to above 900° C., such as above 1,000° C. in the present example.

Flow 140 of pyrolysis gases 122 at the working temperature is delivered directly to reduction furnace 104 through furnace inlet 142. Reduction furnace 104 is a direct iron reduction (DRI) furnace designed for reducing a metal oxide 144 embodied in this example by iron ore, which is typically delivered in the form of iron pellets, to iron 102. Iron 102 in the form of molten metal is shown leaving DRI furnace 104 through a bottom furnace outlet 148. According to the invention it is preferable that pyrolysis gases 122 contain a sufficient fraction of carbon in the form of either small particulates that were not filtered out as pyrolysis carbon product 118 by high-temperature cyclone 126, or in the form of hydrocarbons such as in hydrocarbon fraction 120 to create a desirable fraction of iron carbide inside DRI furnace 104.

DRI furnace 104 has a top furnace outlet 150 to allow a top gas 152 to leave. Top gas 152 exiting DRI furnace 104 still contains unreacted pyrolysis-derived hydrogen 106′ and some water 154. A prime is used in referencing unreacted hydrogen 106′ in top gas 152 in order to distinguish it. These components of top gas 152 are also visualized in highly magnified molecular form within dashed and dotted outlines. It is advantageous to recycle unreacted pyrolysis-derived hydrogen 106′, as indicated in the dashed line 166 and explained in more detail below.

The metal oxide embodied by iron ore 144 in the present embodiment is reduced to iron 102 inside DRI furnace 104. It exits a bottom furnace outlet 148 in the form of molten metal iron 102 and is delivered to an Electric Arc Furnace 156 (EAF). EAF 156 has electrodes 158 for passing large electrical currents to cause electric arcs that heat the content of an interior chamber 160. Electrodes 158 are typically made of graphite and are powered by electricity derived from a suitable power source (not shown). Thus, EAF 156 with the aid of electrodes 158 heats interior chamber 160 that contains molten metal iron 102. This causes molten metal iron 120 to be processed to steel 103, which is the final product in the present embodiment.

EAF 156 has an outlet 162 for recovering steel 103. A product vessel 164 is provided for collecting recovered steel 103. Steel 103 in product vessel 164 is shown in its crude form.

The invention further extends to the operation of system 100 to obtain the desired metal oxide reduction product, in the present case reduced iron 102. In other words, in order to deliver desired product, i.e., reduced iron 102, system 100 needs to be operated in a certain manner.

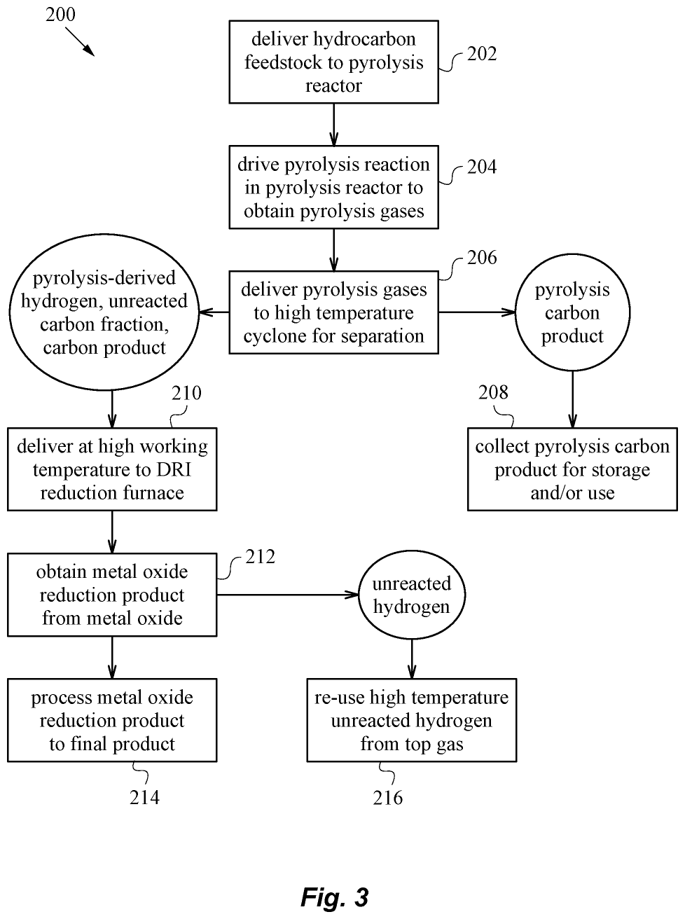

The operation of system 100 according to the invention including specific steps will now be explained with reference to a flow diagram 200 shown in FIG. 3 and with reference to elements illustrated in FIG. 2. In a first step 202 hydrocarbon feedstock 110, in the form of natural gas in the present embodiment, is delivered or provided to pyrolysis reactor 108. Natural gas 110 is a low-cost resource and it is obtained from any suitable existing natural gas infrastructure. Such infrastructure is known to those skilled in the art from ironmaking and steelmaking plants.

In a subsequent step 204, pyrolysis of natural gas 110 is driven in pyrolysis reactor 108 in an oxygen-free environment. The energy for driving the pyrolysis reaction is provided by power supply 124. Preferably, power supply 124 uses grid electricity or renewable electricity for driving the pyrolysis reaction. Renewable electricity from hydro-electric, nuclear, or wind and solar with energy storage is an advantageous choice for power supply 124. It is important to perform pyrolyzation step 204 at a pyrolyzation temperature between 500° C. and 1,600° C. Pyrolysis gases 122 thus obtained essentially include pyrolysis carbon product 118, hydrocarbon fraction 120 and pyrolysis-derived hydrogen 106.

In a following step 206, pyrolysis gases 122 produced by performing pyrolysis in step 204 are delivered to high-temperature cyclone 126. During step 206 pyrolysis gases 122 are separated such that pyrolysis carbon product 118, here mostly in the form of solid carbon 138 is discharged from bottom outlet 134 of high-temperature cyclone 126. Preferably, between 50% and 100% of pyrolysis carbon product 118 by mass is separated during step 206. It is important that step 206 be performed while maintaining pyrolysis gases 122 at a working temperature that is below the pyrolyzation temperature, but is still high such as between 900° C. and 1,000° C. This is done to maintain low CO₂ emissions, as excess solid carbon 138 could turn into CO₂. Maintaining high working temperature also improves the energy efficiency of the process by eliminating the need to reheat pyrolysis-derived hydrogen 106.

In a step 208 pyrolysis carbon product 118 separated in cyclone 126 in step 206 is sent to collection vessel 136. During this step precautions are taken to ensure that at most 5% of pyrolysis-derived hydrogen 106 is lost. Again, pyrolysis carbon product 108 is in the form of solid carbon 138 and it can thus be collected and stored for various applications in vessel 136.

Meanwhile, in a step 210 pyrolysis gases 122 exiting through central outlet pipe 132 are sent in the form of gas flow 140 to DRI reduction furnace 104. Note that flow 140 contains pyrolysis-derived hydrogen 106 and unreacted carbon fraction 120 separated in high-temperature cyclone 126 as well as a small amount of pyrolysis carbon product 118 that was not separated in high-temperature cyclone 126. It is important that flow 140 of pyrolysis gases 122 be maintained at the working temperature that is below the pyrolyzation temperature but still high, e.g., above 1,000° C. Maintaining such high working temperature is important to ensure that no additional heating of flow 140 is required prior to entering DRI furnace 104.

In another step 212, metal oxide reduction product 102, here reduced iron (Fe), is obtained in DRI furnace 104 using flow 140 in the metal oxide reduction reaction. It should be noted that according to the invention the metal oxide reduction reaction can be practiced with other metal oxides besides iron ore 144. Specifically, besides iron ore 144 metal oxide reduction reaction can be practiced with metal oxides selected from among tin oxide, lead oxide, nickel oxide, copper oxide and cobalt oxide. In those cases, metal oxide reduction product 102 will be the corresponding reduced metal.

In a step 214 metal oxide reduction product 102 in the form of molten metal iron 102 is delivered to an Electric Arc Furnace 156 (EAF) for further processing. EAF 156 heats molten iron 102 to produce steel 103, which is the final product in the present embodiment.

As already noted above, DRI furnace 104 has a top furnace outlet 150 to allow top gas 152 that contains unreacted pyrolysis-derived hydrogen 106′ and some water 154 to leave. It is advantageous to take advantage of top gas 152 by re-using unreacted hydrogen 106′ it contains, as indicated with dashed arrow 166 in FIG. 2.

Therefore, in a step 216 top gas 152 containing unreacted hydrogen 106 is re-used or recycled. Optionally, during step 216 unreacted hydrogen 106 is purified to remove water 154 and any carbon dioxide as well as other impurities. Optionally, unreacted hydrogen 106′ is preheated by pyrolysis gases 122 to achieve the desired working temperature. Then, unreacted hydrogen 106′ is combined with flow 140 of pyrolysis gases 122 and fed back into DRI furnace 104 through furnace inlet 142 for use in the combustion process.

Some pyrolysis-derived hydrogen 106 can also be recycled upon exiting pyrolysis reactor 108. Some of it is combusted in DRI furnace 104 to provide sufficient energy to sustain the endothermic metal oxide reduction reaction of iron ore 144 to metallic iron 102 with pyrolysis-derived hydrogen 106. By not letting pyrolysis-derived hydrogen 106 cool down after exiting pyrolysis reactor 108, significant energy savings are achieved. High-temperature cyclone 126 that removes pyrolysis carbon product 118, in the present case solid carbon 138, while maintaining pyrolysis-derived hydrogen 106 at high working temperature is critically important to achieving low carbon dioxide emissions from the process.

In some cases, pyrolysis carbon product 118 is fluidized out of pyrolysis reactor 108 by pyrolysis gases 122. Further, when hydrocarbon feedstock 110 comprises methane it is advantageous to maintain the efficiency of the pyrolysis reaction in pyrolysis reactor 108 such that pyrolysis-derived hydrogen 106 is obtained with a yield of more than 70%.

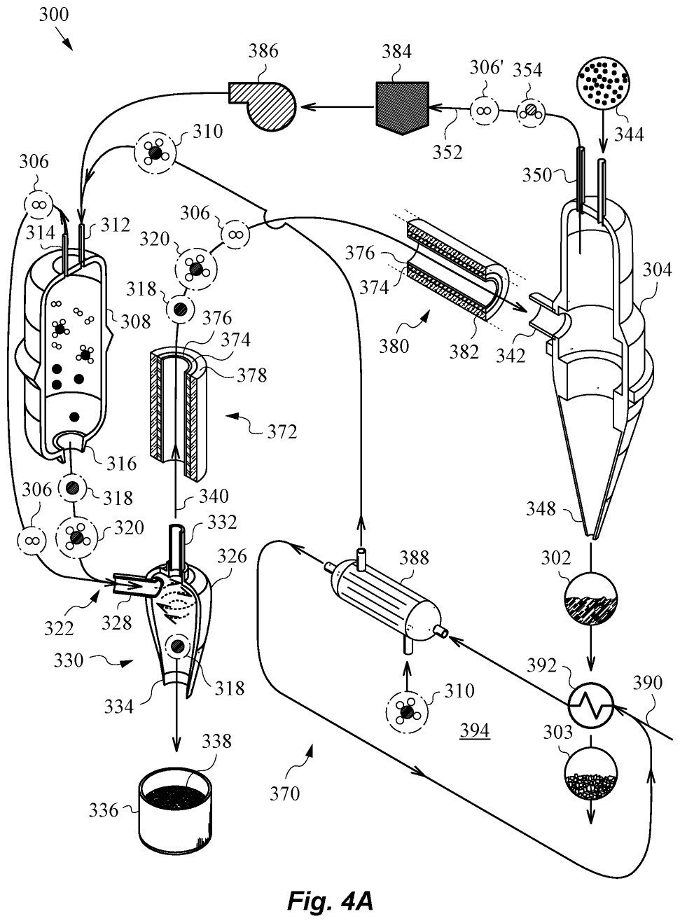

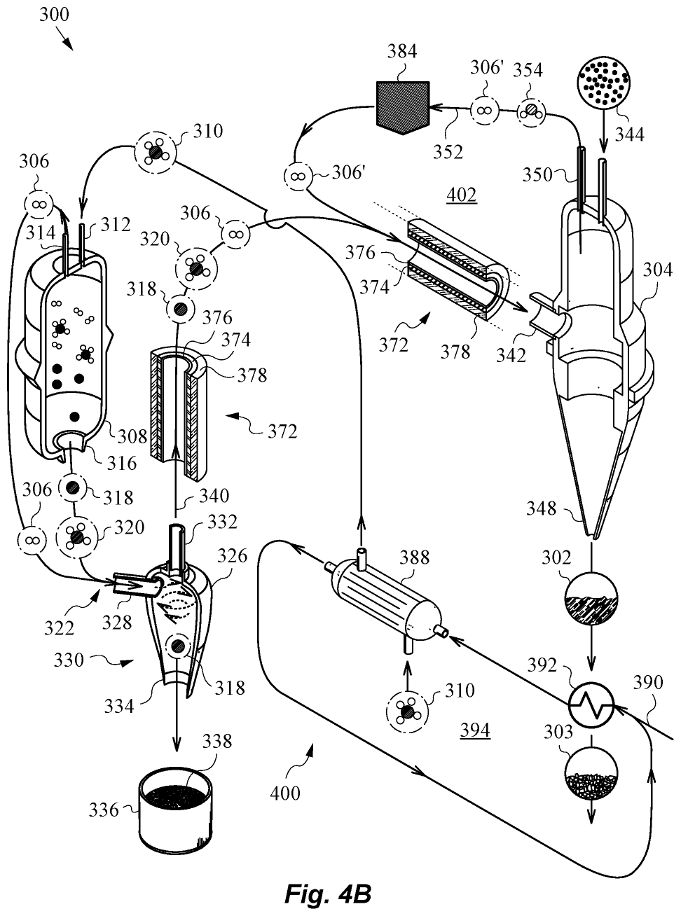

FIG. 4A in schematic diagram illustrating another system 300 for obtaining a metal oxide reduction product 302 and further incorporating a thermal management system 370. Metal oxide reduction product 302 is again embodied by reduced iron (Fe) or metallic iron shown in molten form. Reduced iron 302 is obtained in a metal oxide reduction reaction performed in a reduction furnace 304 using a pyrolysis-derived hydrogen 306.

System 300 has a pyrolysis reactor 308 for pyrolyzing a hydrocarbon feedstock 310 such as methane or natural gas. In the present embodiment hydrocarbon feedstock is natural gas 310. Natural gas 310 is visualized in highly magnified molecular form by its most abundant component, methane (CH₄), within a dashed and dotted outline.

Pyrolysis reactor 308 has an inlet 312 for admitting natural gas 310, a top outlet 314 for releasing pyrolysis-derived hydrogen 306 and a bottom outlet 316 for releasing a pyrolysis carbon product 318. The latter is solid carbon visualized in highly magnified molecular form within a dashed and dotted outline. Pyrolysis reactor 308 also releases a hydrocarbon fraction 320 (principally composed of unreacted natural gas 310) through bottom outlet 316. Together, pyrolysis-derived hydrogen 306, pyrolysis carbon product 318 and hydrocarbon fraction 320 constitute pyrolysis gases 322.

Pyrolysis reactor 308 is connected to an electrical power supply (not shown) for heating it to a pyrolyzation temperature between 500° C. and 1,600° C. The power supply generates a sufficient amount of power to reach pyrolyzation temperatures above 1,100° C. and thus drive pyrolyzation.

In accordance with the invention, system 300 has a high-temperature carbon separator 326 positioned to receive pyrolysis gases 322 through a peripheral inlet 328. Since pyrolysis gases 322 exit pyrolysis reactor 308 at temperatures above 1,000° C. high-temperature carbon separator 326 is a duly insulated and refractory-lined high-temperature separator. Its peripheral inlet 328 is also duly insulated and made of materials that can withstand the high temperature of pyrolysis gases 322. Likewise, an interior chamber 330 of high-temperature carbon separator 326 is insulated and made of materials that can withstand the high temperature of pyrolysis gases 322.

Pyrolysis gases 322 undergo separation within interior chamber 330 such that a majority of the large and heavy pyrolysis carbon product 318 drops out under gravity through a bottom outlet 334 of interior chamber 330. Separated pyrolysis carbon product 318 drops into a collection vessel 336 is positioned below bottom outlet 334 for collecting pyrolysis carbon product 318, which at this point is mostly composed of solid carbon 338.

Central outlet pipe 332 at the top of interior chamber 330 allows the remainder of pyrolysis gases 322 to exit high-temperature carbon separator 326 in the form of a flow 340. Pyrolysis gases 322 exiting through central outlet pipe 332 at the top as flow 340 consist mostly of pyrolysis-derived hydrogen 306 and a small amount of hydrocarbon fraction 320 and pyrolysis carbon product 318 that did not get separated in high-temperature carbon separator 326. As in the previous embodiment, additional high-temperature carbon separators can be used to achieve a higher separation efficiency.

Upon exiting central outlet pipe 332 flow 340 of pyrolysis gases 322 at working temperature and mostly consisting of pyrolysis-derived hydrogen 306 enters thermal management system 370. Thermal management system 370 in the present embodiment has a number of elements that are shown partially for reasons of clarity.

In accordance with the invention, thermal management system 370 is specifically designed to leverage the high working temperature of pyrolysis-derived hydrogen 306 from the methane pyrolysis reaction conducted in pyrolysis reactor 308. To that end, thermal management system 370 has a delivery piping 372 for delivering flow 340 containing pyrolysis-derived hydrogen 306 directly to reduction furnace 304 through a furnace inlet 342. Only a small section of delivery piping 372 leading from high-temperature carbon separator 326 to reduction furnace 304 is shown in FIG. 4A. Also, delivery piping 372 is shown with a cutaway to better visualize its construction.

Delivery piping 372 is made of a steel or stainless steel pipe 374 that has an inner ceramic refractory lining 376. In addition, delivery piping 372 has an external insulation 378 enveloping pipe 374 for minimizing heat loss. Thus, delivery piping 372 of thermal management system 370 is designed to maintain the high working temperature of flow 340 of pyrolysis gases 322 that contain pyrolysis-derived hydrogen 306. Specifically, the construction of delivery piping 372 supports transport of pyrolysis gases 322 at working temperatures in excess of 900° C. It should be noted, that piping similar to delivery piping 372 can be deployed for transporting pyrolysis gases 322 between pyrolysis reactor 308 and high-temperature carbon separator 326.

In the present embodiment, delivery piping 372 of thermal management system 370 also has a control piping section 380 with a low thermal insulation 382 around pipe 374. The amount of heat loss afforded by low thermal insulation 382 of control piping section 380 is tuned to achieve a certain reduction in the temperature of pyrolysis gases 322 prior to arriving in reduction furnace 304 for reasons explained below.

Delivery piping 372 transports flow 340 of pyrolysis gasses 322 to furnace inlet 342 of reduction furnace 304. In the present embodiment reduction furnace 304 is a direct iron reduction (DRI) furnace designed for reducing a metal oxide 344, in this example iron ore delivered as iron pellets, to iron 302. Iron 302 in the form of molten metal is shown leaving DRI furnace 304 through a bottom furnace outlet 348. According to the invention it is preferable that pyrolysis gases 322 contain a sufficient fraction of carbon in the form of either small particulates that were not filtered out as pyrolysis carbon product 318 by high-temperature carbon separator 326, or in the form of hydrocarbons such as in hydrocarbon fraction 320 to create a desirable fraction of iron carbide inside DRI furnace 304.

Now, the reduction of iron oxide 344 to metallic iron 102 in DRI furnace 304 is typically performed at temperatures between 650° C. and 1,200° C. At temperatures over 1,100° C. iron 302 in its metallic iron phase begins to soften and can stick together and clog DRI furnace 304. Therefore, control piping section 380 of delivery piping 372 is tuned to cool down pyrolysis gases 322 prior to flowing into DRI furnace 304 to below 1,100° C.

DRI furnace 304 has a top furnace outlet 350 to allow a top gas 352 to leave. Top gas 352 exiting DRI furnace 304 still contains unreacted pyrolysis-derived hydrogen 306′ and some water 354. A prime is used in referencing unreacted hydrogen 306′ in top gas 352 in order to distinguish it. The main components of top gas 352 are also visualized in highly magnified molecular form within dashed and dotted outlines. Typically, top gas 352 exits DRI furnace 304 at temperatures below 300° C. These temperatures are lower than the reduction reaction temperature in DRI furnace 304. However, it is preferred for hot reduction gases, in the present case pyrolysis-derived hydrogen 306, to flow in a counter-flow up through iron ore 344 and heat it up before it enters the reduction zone of DRI furnace 304. In heating up iron ore 344 pyrolysis-derived hydrogen 306 is cooled down before it exits DRI furnace 304 through top furnace outlet 350.

Although the primary components of top gas 352 are unreacted pyrolysis-derived hydrogen 306′ and water 354, a small amount of carbon dioxide and any still unreacted hydrocarbons (not shown) are also present. The fraction of unreacted hydrocarbons should be very low, as they readily decompose in DRI furnace 304, since iron ore 344 is a known catalyst for the decomposition of hydrocarbons at elevated temperatures. Additionally, the concentration of any carbon dioxide at top furnace outlet 350 is also very low as most of the carbon will have been removed in the form of solid carbon 338 in high-temperature carbon separator 326.

In the embodiment of FIG. 4A top gas 352 is recycled within system 300 as a carrier gas to pyrolysis reactor 308. In order to recycle top gas 352 system 300 has a condenser 384 for cleaning or scrubbing top gas 352. Specifically, condenser 384 is designed for drying top gas 352 by removing water 354. Condenser 384 is also designed to remove any dust from top gas 352. Thus, the primary component of top gas 352 remaining after drying and cleaning in condenser 384 is unreacted pyrolysis-derived hydrogen 306′. In cases where further purification of top gas 352 is necessary the primarily pyrolysis-derived hydrogen 306′ containing gas exiting condenser 384 can also be routed through a pressure swing adsorber (not shown) to remove any minor amount of CO₂ or other gasses from pyrolysis-derived hydrogen 306′ before recycling. Furthermore, a compressor pump 386 is provided to compress the primarily pyrolysis-derived hydrogen 306′ gas from condenser 384 prior to recycling it to pyrolysis reactor 308 as carrier gas through inlet 312 that also admits natural gas 310.

Thermal management system 370 is further designed to fully integrate the process according to the invention and maximize energy efficiency while minimizing the required electricity input to drive the pyrolyzation reaction in pyrolysis reactor 308. To accomplish this, thermal management system 370 takes advantage of the high amount of heat contained in iron 302 and any carbon (not shown) exiting DRI furnace 304 through bottom furnace outlet 348. Specifically, iron 302 and carbon exit DRI furnace 304 at a temperature of about 1,000° C. and thus have a large potential for heat exchange with hydrocarbon feedstock 310. Such heat exchange is very advantageous as it reduces the amount of energy, e.g., electricity, that is needed for pre-heating hydrocarbon feedstock 310 prior to sending it to pyrolysis reactor 308. An additional advantage of heat exchange is that it is essential to cool iron 302 to prevent oxidation in air.

Consequently, thermal management system 370 is equipped with a heat exchanger 388 that deploys an inert gas 390 as the heating medium or working fluid. Argon, nitrogen or helium can be used as working fluid 390, with nitrogen being preferred due to its low cost. Inert gas 390 is supplied from a suitable source (not shown) and passes through a heater 392 where it absorbs heat from iron 302 and carbon. Then, inert gas 390 passes to heat exchanger 388. There it transfers heat to hydrocarbon feedstock 310, which is the working fluid in this configuration. Upon exiting heat exchanger 388 inert gas 390 is recirculated in a circulation loop 394 through working heat exchanger 392 to again absorb heat from iron 302 and carbon. Any losses of inert gas 390 in circulation loop 394 are made up by additional supply of fresh inert gas 390 from its source (not shown).

The pre-heating of hydrocarbon feedstock 310, here embodied by process methane, prior to pyrolysis in pyrolysis reactor 308 represents an important piece of integration to minimize electricity consumption. It is advantageous to turn reduced iron 302 into hot briquetted iron 303. This occurs at 600° C., meaning that heat exchange process in circulation loop 394 should most preferably occur in two stages, before and after the briquetting process. This will allow circulation loop 394 to extract the full sensible heat from hot iron 302. Thus, working heat exchanger 392 extracts the sensible heat from hot iron 302 and/or carbon and working fluid here embodied by inert gas 390 transfers the heat from iron 302 or carbon to input hydrocarbon feedstock 310 such as natural gas.

A person skilled in the art will recognize that many other well-known heat transfer mechanisms can be deployed in other variants of thermal management system 370. For example, one can use the waste heat from hot iron 302 and carbon to heat up steam in order to run a steam turbine to generate electrical power to run the process. The fraction of energy that can be recovered from a steam turbine will increase as the system size increases since turbine efficiency typically increases with increasing size. If the turbine efficiency can reach >35%, this method can use the waste heat to heat up the incoming natural gas or hydrocarbon feedstock 310.

Returning to the embodiment shown in FIG. 4A, we note that heated hydrocarbon feedstock 310 exiting heat exchanger 388 is mixed with carrier gas. Carrier gas consists primarily of pyrolysis-derived hydrogen 306′ scrubbed from top gas 352 by condenser 384 and compressed by compressor pump 386. Together, pyrolysis-derived hydrogen 306′ and hydrocarbon feedstock 310 are admitted into pyrolysis reactor 308 via inlet 312.

In sum, the primary inputs into system 300 are hydrocarbon feedstock such as natural gas 310, electricity to drive pyrolyzation in pyrolysis reactor 308 and metal oxide reduction reaction in DRI furnace 304 and iron ore 344. The primary outputs are water 354 in the form of steam, pyrolysis carbon product 138 and reduced iron 302, here in the final form of hot briquetted iron 303.

FIG. 4B is a schematic diagram illustrating an embodiment of system 300 for obtaining a metal oxide reduction product 302 incorporating a thermal management system 400 with a recycle loop 402. This embodiment of system 300 includes analogous elements operating in the same manner as described in the embodiment of FIG. 4A. These elements are called out with the same reference numbers. In contrast to thermal management system 370 of FIG. 4A, thermal management system 400 is designed to cool flow 340 of pyrolysis gases 322 in a manner that does not require any control piping sections for cooling through heat loss. Instead, thermal management system 400 deploys recycle loop 402 to achieve cooling of pyrolysis gases 322 in flow 340.

Thermal management system 400 uses delivery piping 372 for delivering flow 340 containing pyrolysis-derived hydrogen 306 directly to reduction furnace 304 through a furnace inlet 342. Two small sections of delivery piping 372 leading from high-temperature carbon separator 326 to reduction furnace 304 are shown in FIG. 4B. Again, delivery piping 372 is shown with a cutaway to better visualize its construction. It is made of a steel or stainless steel pipe 374 that has an inner ceramic refractory lining 376 and an external insulation 378 enveloping pipe 374 for minimizing heat loss. Thus, delivery piping 372 of thermal management system 400 is designed to maintain a temperature of over 900° C. of flow 340 of pyrolysis gases 322 that contain pyrolysis-derived hydrogen 306.

Again, because at temperatures over 1,100° C. iron 302 in its metallic iron phase begins to soften and can stick together and clog DRI furnace 304 it is desirable to cool down pyrolysis gases 322 prior to flowing into DRI furnace 304 to below 1,100° C. Thermal management system 400 uses recycle loop 402 to accomplish this task. Specifically, top gas 352 exiting DRI furnace 304 through top furnace outlet 350 is deployed in recycle loop 402 to achieve cooling of pyrolysis gases 322 of flow 340. Top gas 352 containing unreacted pyrolysis-derived hydrogen 306′, some water 354 (in the form of steam) a small amount of carbon dioxide and any still unreacted hydrocarbons (not shown) exits at temperatures below 300° C. and is thus a good candidate for achieving the required cooling.

Recycle loop 402 cleans top gas 352 using condenser 384 to dry top gas 352 by removing water 354 and also to remove any dust. Consequently, the primary component of top gas 352 remaining after condensation and filtration in condenser 384 is unreacted hydrolysis-derived hydrogen 306′. Now, after drying, top gas 352 containing hydrogen 306′ at 300° C. or lower is admitted into delivery piping 372 of thermal management system 400 thus closing recycle loop 402. In mixing and heat exchanging with pyrolysis gasses 322 in flow 340 low temperature unreacted hydrolysis-derived hydrogen 306′ from top gas 352 achieves the desired cooling of pyrolysis gasses 322 prior to their entry into DRI furnace 304. The low temperature unreacted pyrolysis-derived hydrogen 306′ injected into flow 340 will also participate in the combustion in DRI furnace 304 to offset the endothermic reaction of metal oxide reduction that yields iron 302.

In either embodiment of thermal management system 370 or 400 additional modifications can be implemented. For example, a buffer storage tank can be used to simplify the metering of gas in these embodiments. Alternatively, purified unreacted pyrolysis-derived hydrogen 306′ from top gas 352 can be put to other uses as well. In some embodiments it can be removed from the system and provided to a third party or it can be used in a fuel cell to generate renewable energy. In still other embodiments excess reducing gas in the form of purified unreacted pyrolysis-derived hydrogen 306′ can be re-heated and used in the reduction process yielding iron 302 to increase the rate of the reduction reaction without necessarily being used to cool pyrolysis gasses 322.

According to yet another alternative, purified unreacted pyrolysis-derived hydrogen 306′ can be re-heated and injected into flow 340 of pyrolysis gasses 322 either before, during or after entering high-temperature carbon separator 326. Injection before or during the separation process in high-temperature carbon separator 326 permits it to operate at lower temperatures which is beneficial from a materials of construction and thermal loss perspective.

In still other embodiments, thermal management system 370 or 400 can be designed to dry and combust unreacted pyrolysis-derived hydrogen 306′ to obtain high-temperature gases for injection into DRI furnace 304 in order to add heat. Finally, combinations of thermal management systems 370 and 400 can also be used to achieve, cooling of pyrolysis gasses 322 at any stage of their transport to DRI furnace 304, use pyrolysis-derived hydrogen 306′ in top gas 352 as carrier gas for injection into pyrolysis reactor 308 along with hydrocarbon feedstock 310 and to serve still other functions outside the system of invention. The connections that such variants of thermal management systems 370 and/or 400 would require can be implemented by those skilled in the art based on well-known techniques.

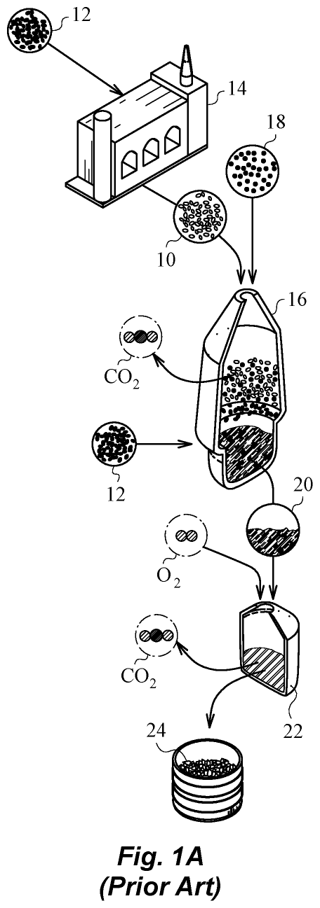

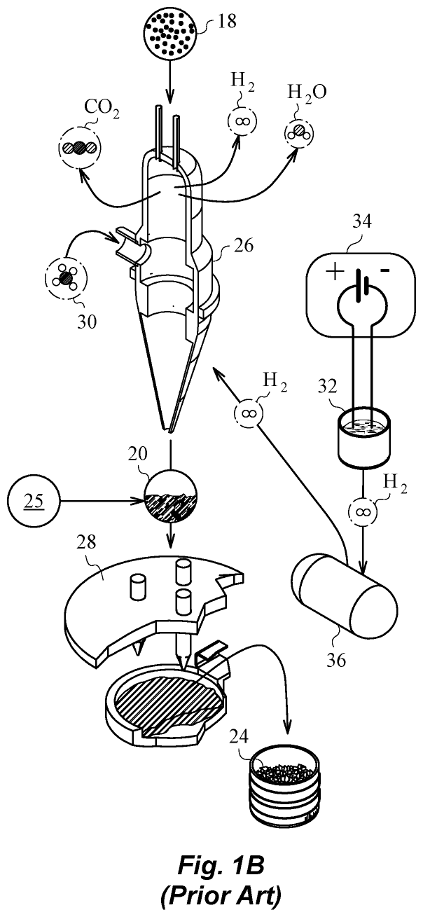

Full integration of the methods and systems of the invention has the potential at scale to achieve an input electrical energy intensity of 0.7 MWhe/ton of iron. This represents a greater than 75% reduction in electrical energy intensity over the state of the art H₂-DRI production using water electrolysis (see FIG. 1B Prior Art). By using DRI furnace that runs the metal oxide reduction process using the methane pyrolysis-DRI system of the invention with electric arc furnace (EAF) for clean steel production with a carbon intensity of 0.28 tons of CO e/ton of crude steel, this invention should achieve an 85% reduction on existing BF-BOF crude steel carbon intensity.

The net energy input for methane pyrolysis driven hydrogen reduction of iron ore is 4.5 times lower than the water electrolysis route for making clean hydrogen. This is illustrated in Table 3 below.

TABLE 3

| Reaction | Enthalpy (kJ/mol) |
|---|---|
| 4.5CH4 --> 4.5C + 9H2 | 337.05 |
| 3Fe2O3 + 9H2 --> 6Fe + 9H2O | 296.24 |
| 3Fe2O3 + 4.5CH4 --> 4.5C + 6Fe + 9H2O | 633.3 |

When applying this invention to steel production, a total reduction in carbon dioxide emission of 85% over current blast furnace steel production (see FIG. 1A Prior Art) can be achieved. Again, this is accomplished by integrating clean, pyrolysis-derived hydrogen produced via methane pyrolysis to reduce iron ore to iron in a direct metal oxide reduction reaction. When directly integrated with DRI furnace as described in this invention, further overall process energy and cost savings are possible through removal of balance-of-plant components for heat recovery, compression, and gas purification. Using clean pyrolysis-derived hydrogen from methane pyrolysis to produce DRI and input it into EAF to make steel has the potential to eliminate up to 60 million tons of CO₂ of the 84 million tons of GHG emissions from crude steel production in the United States.

The present methane pyrolysis and DRI furnace reduction process takes advantage of the best aspects of natural gas (NG) DRI with reforming and electrolytic hydrogen (eH₂) DRI with water electrolysis while removing barriers to large scale adoption. The methane pyrolysis process produces carbon-neutral pyrolysis-derived hydrogen by thermally decomposing natural gas with renewable electricity into solid carbon and H₂, thus avoiding CO₂ emissions associated with traditional steam reforming. Similar to NG DRI, this enables a scalable production route that leverages the world's low-cost natural gas resources. Unlike NG DRI, the ironmaking process produces no CO₂ and presents a route to carbon-neutral steel production.

With improvements in heat integration, the process of invention has the potential to produce carbon neutral iron for steel production while using over 4 times less renewable electricity than current approaches using DRI with hydrogen from water electrolysis or electrochemical reduction of iron ore to iron. The improved energy efficiency minimizes additional infrastructure buildout and enables the process to run continuously while utilizing existing electric and natural gas infrastructure at ironmaking and steelmaking plants. This eliminates the need for costly hydrogen compression and storage systems.

The present invention improves the energy efficiency of the coupled methane pyrolysis and DRI process by as much as 36% through direct integration of the two technologies, both of which operate at similar high temperatures.

Table 4 below identifies the target level of performance in comparison to prior art baseline blast furnace and basic oxygen furnace (BF+BOF) steelmaking process and prior art (state-of-the-art) direct reduction of iron followed by an electric arc furnace using natural gas (NG DRI+EAF) or hydrogen from water electrolysis (eH₂ DRI+EAF). Table 4 lists 4 leading factors that impact successful achievement of efficiency and decarbonization as provided for in accordance with the invention.

TABLE 4

| | | Target | Baseline | State-of-the- |
|---|---|---|---|---|
| Objective/ | | (present | (BF + | art low-CO₂ |
| Goal | Metric | invention) | BOF) | (DRI + EAF) |
| Reduce carbon | % carbon | 70%-85% | 1.9 tons | 30-50% |
| intensity of | intensity | reduction | CO₂/ | reduction |
| iron & steel | change | | ton crude | (NG DRI), |
| industry | per ton | | steel | 70-85% |
| manufacturing | CO₂e/ton- | | | reduction |
| | crude steel | | | (eH2 DRI |
| Minimize | MWhe/ | 0.7-1.1 | 0.365 | 0.313 MWhe/ton |
| electricity | ton DRI | MWhe/ | MWhe/ | DRI (NG DRI), |
| consumption | | ton DRI | ton pig | >3 MWhe/ |
| | | | iron | ton DRI |
| | | | | (eH2 DRI) |
| Maintain DRI | % carbon | 0.5 (min)-5% | 4-5% (BF | 0.5-4.5% (NG |
| carbon content | in pig iron | | pig iron) | DRI), 0% |
| for EAF | | | | (eH2 DRI), 0% |
| (critical for | | | | is undesirable |
| steel quality) | | | | for steelmaking |
| Metallization | % Fe | >90% (min), | >90% | >90% |
| (critical for | (metallic)/% | >95% | | |
| DRI quality) | Fe (total) | | | |

As compared to the global baseline steelmaking BF+BOF process, the present methane pyrolysis and DRI shaft furnace method and system has the potential to reduce CO₂ emissions by as much as 85%. When using methane pyrolysis hydrogen in a DRI shaft furnace, all process emissions for ironmaking can be eliminated, leaving only process emissions of 0.28 tons of CO/ton of crude steel from EAF steelmaking, which exist even when using zero-CO₂ electricity. The state-of-the-art Midrex process with natural gas DRI ironmaking reduces CO₂ emissions to a lesser extent than the proposed technology. Only state-of-the-art DRI reduction with electrolytic hydrogen production, as proposed in several planned commercial projects in Europe and China, has the potential to achieve a similar CO₂ reduction as the target set by the present invention.

There are a number of other advantages to the systems and methods of the invention. For example, it is known that incorporation of solid carbon by-product directly into the iron matrix is desirable for downstream steel production. Specifically, since a carbon content in iron introduced into EAF is between 1-5% by mass and the present system delivers some unreacted pyrolysis product from the pyrolysis reactor the need for external sources of carbon for EAF are eliminated. More precisely, the required carbon content for EAF translates to about 5-35% of the total pyrolysis carbon product obtained from the pyrolysis reactor. Thus, in some embodiments of the invention the amount of carbon product filtered out in the high-temperature carbon separator or series of high-temperature carbon separators should ensure that a sufficient amount of carbon product remains in the flow of pyrolysis gases to yield a 1-5% carbon content when the iron arrives in the EAF.

In fact, the flow of pyrolysis gasses from the methane pyrolysis reactor can be regulated in accordance with downstream needs. For example, after pyrolysis carbon product separation in high-temperature carbon separator or series of high-temperature carbon separators, the unreacted hydrocarbon fraction of methane can be tuned to contain anywhere from <2% to >50% methane by volume. The separation in high-temperature carbon separator can be tuned to contain <5% to >25% of the solid carbon by mass in the flow of pyrolysis gases (i.e. to separate out and remove 50 to 100% of the solid carbon by mass in the gas flow).

Furthermore, methane pyrolysis from biogenic sources of methane such as wastewater treatment plants, dairy farms, and landfills presents a route to carbon-negative steel production. In those cases, the carbon in the methane is removed in the pyrolysis process as a solid that can be sequestered.

It will be apparent to one skilled in the art that a wide range of methane conversions in the methane pyrolysis reactor and carbon separation efficiencies in the high-temperature carbon separator can be used to tune the iron product and emissions of the furnace. Ideally, methane to hydrogen conversion is as high as possible and carbon separation is as high as needed to remove all carbon from the reducing gas stream except that which is incorporated into the iron product. For example, to achieve zero process CO₂ emissions at a carbon incorporation into iron of 5 mass %, approximately 70% of the carbon must be removed from the system as a solid prior to entering the shaft furnace (assuming all carbon entering into the shaft furnace up to 5 mass % incorporates into the iron product), meaning that at 100% methane conversion to solid carbon and hydrogen the cyclone system needs to be 70% efficient, and at 70% methane conversion to solid carbon and hydrogen the cyclone system needs to be 100% efficient. Even lower efficiencies (<70%) of methane conversion to solid carbon and hydrogen and solid carbon separation in the high temperature cyclone would function well in the present invention, although operating the system in this way would increase the overall system CO₂ emissions.

It will be evident to a person skilled in the art that the present invention admits of various other embodiments. Therefore, its scope should be judged by the claims and their legal equivalents.

1. A metal oxide reduction product obtained in a metal oxide reduction reaction with a pyrolysis-derived hydrogen, wherein said metal oxide reduction product is obtained by a process comprising:
a) providing a pyrolysis reactor for pyrolyzing a hydrocarbon feedstock into pyrolysis gases at a pyrolyzation temperature, said pyrolysis gases essentially comprising a pyrolysis carbon product, a hydrocarbon fraction and said pyrolysis-derived hydrogen;
b) feeding said pyrolysis gases from said pyrolysis reactor to at least one high-temperature carbon separator for separating said pyrolysis carbon product from said pyrolysis gases while maintaining said pyrolysis gases at a working temperature below said pyrolyzation temperature; and
c) providing a flow of said pyrolysis gases from said at least one high-temperature carbon separator to a reduction furnace running said metal oxide reduction reaction whereby said pyrolysis-derived hydrogen participates in said metal oxide reduction reaction.

2. The metal oxide reduction product of claim 1, wherein said process further comprises providing a thermal management system for maintaining said working temperature of said pyrolysis gases.

3. The metal oxide reduction product of claim 2, wherein said thermal management system dries and combusts an unreacted hydrogen portion of said pyrolysis-derived hydrogen to obtain high-temperature gases for injection into said reduction furnace to add heat.

4. The metal oxide reduction product of claim 6, wherein said thermal management system dries and injects into said flow of said pyrolysis gases an unreacted hydrogen portion for cooling said flow of said pyrolysis gases prior to entry into said reduction furnace.

5. The metal oxide reduction product of claim 2, wherein said thermal management system comprises a recycle loop for recirculating a reduction furnace exit gas into said reduction furnace.

6. The metal oxide reduction product of claim 1, wherein said metal oxide reduction reaction is practiced with a metal oxide selected from the group consisting of iron ore, tin oxide, lead oxide, nickel oxide, copper oxide, and cobalt oxide.

7. The metal oxide reduction product of claim 3, wherein said hydrocarbon feedstock is selected from the group consisting essentially of methane, natural gas and said pyrolysis carbon product comprises solid carbon.

8. The metal oxide reduction product of claim 1, wherein said working temperature is from above 300° C. to above 900° C.

9. The metal oxide reduction product of claim 1, wherein said pyrolyzation temperature is between 500° C. and 1,600° C.

10. The metal oxide reduction product of claim 1, wherein said high-temperature carbon separator is selected from among a high-temperature cyclone, a high-temperature baghouse filter and a high-temperature candle filter.

11. The metal oxide reduction product of claim 1, wherein said hydrocarbon feed comprises methane and an efficiency of said pyrolysis reaction is maintained such that said pyrolysis-derived hydrogen is obtained with a yield of more than 70%.

12. The metal oxide reduction product of claim 1, wherein said at least one high-temperature carbon separator separates out over 60% up to and over 90% of said pyrolysis carbon product from said pyrolysis gases.

13. A system for obtaining a metal oxide reduction product in a metal oxide reduction reaction with a pyrolysis-derived hydrogen, wherein said system comprises:
a) a pyrolysis reactor for pyrolyzing a hydrocarbon feedstock into pyrolysis gases at a pyrolyzation temperature such that said pyrolysis gases essentially comprise:
1) a pyrolysis carbon product;
2) a hydrocarbon fraction; and
3) said pyrolysis-derived hydrogen;
b) at least one high-temperature carbon separator for receiving said pyrolysis gases from said pyrolysis reactor and for separating said pyrolysis carbon product from said pyrolysis gases while maintaining said pyrolysis gases at a working temperature below said pyrolyzation temperature; and
c) a reduction furnace for receiving a flow of said pyrolysis gases from said at least one high-temperature carbon separator, said reduction furnace running said metal oxide reduction reaction whereby said pyrolysis-derived hydrogen participates in said metal oxide reduction reaction.

14. The system of claim 13, further comprising a thermal management system for maintaining said working temperature of said pyrolysis gases.

15. The system of claim 13, wherein said thermal management system comprises a heat exchanger and is configured for drying and combusting an unreacted hydrogen portion of said pyrolysis-derived hydrogen to obtain high-temperature gases for injection into said reduction furnace to add heat.

16. The system of claim 4, wherein said thermal management system comprises a heat exchanger and is configured for drying and injecting into said flow of said pyrolysis gases an unreacted hydrogen portion for cooling said flow of said pyrolysis gases prior to entry into said reduction furnace.

17. The system of claim 6, wherein said thermal management system comprises a recycle loop for recirculating a reduction furnace exit gas into said reduction furnace.

18. The system of claim 13, wherein said metal oxide reduction reaction is practiced with a metal oxide selected from the group consisting of iron ore, tin oxide, lead oxide, nickel oxide, copper oxide, and cobalt oxide.

19. The system of claim 3, wherein said hydrocarbon feedstock is selected from the group consisting essentially of methane, natural gas and said pyrolysis carbon product comprises solid carbon.
